(19) United States
(12) Patent Application Publication
(10) Pub. No.: US 2024/0105915 A1
(43) Pub. Date: Mar. 28, 2024

(54) COMPOSITE ACTIVE MATERIAL PARTICLE AND BATTERY USING SAME

(71) Applicant: Panasonic Intellectual Property Management Co., Ltd., Osaka (JP)

(72) Inventors: KUNIHIKO MINEYA, Osaka (JP); TADAAKI MATSUMURA, Shiga (JP)

(21) Appl. No.: 18/530,339

(22) Filed: Dec. 6, 2023

Related U.S. Application Data
(63) Continuation of application No. PCT/JP2022/011261, filed on Mar. 14, 2022.

(30) Foreign Application Priority Data
Jun. 21, 2021 (JP) 2021-102771

(51) Int. Cl. H01M 4/36; H01M 4/38; H01M 4/58; H01M 10/0525

(52) U.S. Cl. CPC H01M 4/364; H01M 4/386; H01M 4/5825; H01M 10/0525; H01M 2004/027

(57) ABSTRACT

A composite active material particle of the present disclosure includes a lithium silicate phase, a plurality of silicon particles dispersed in the lithium silicate phase, and an electron-conductive material dispersed in the lithium silicate phase, the electron-conductive material including a carbon material.

### BACKGROUND

### 1. Technical Field

The present disclosure relates to a composite active material particle and a battery using same.

### 2. Description of the Related Art

Development of batteries as power sources has been seen as important with rapid diffusion of electronic products such as personal computers, video cameras, and mobile phones. In automobile industry, development of lithium batteries with high output and high capacity for electric vehicles or hybrid vehicles has been advanced. Alloy-based materials alloyed with lithium have shown promise as negative electrode active materials for high-capacity lithium batteries. A representative material for the alloy-based materials is silicon.

International Publication No. 2016/136180 describes a negative electrode active material including a lithium silicate phase and silicon particles dispersed in the lithium silicate phase.

### SUMMARY

Charge-discharge efficiency of a battery using silicon as an active material is still not sufficient. One non-limiting and exemplary embodiment provides a technique for improving charge-discharge efficiency of a battery using silicon as an active material.

In one general aspect, the techniques disclosed here feature a composite active material particle including a lithium silicate phase, a plurality of silicon particles dispersed in the lithium silicate phase, and an electron-conductive material dispersed in the lithium silicate phase, the electron-conductive material including a carbon material.

According to the present disclosure, charge-discharge efficiency of a battery using silicon as an active material can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional diagram illustrating a schematic configuration of a battery in an embodiment;

FIG. 2 is a sectional diagram illustrating a detailed configuration of a negative electrode and a negative electrode active material layer;

FIG. 3 is a sectional diagram illustrating a schematic configuration of composite active material particles;

FIG. 4A is a diagram explaining a problem of composite active material particles in the related art (for example, International Publication No. 2016/136180); and

FIG. 4B is a diagram explaining an effect provided by composite active material particles according to the present disclosure.

### DETAILED DESCRIPTIONS

### Underlying Knowledge Forming Basis of the Present Disclosure

International Publication No. 2016/136180 discloses improving cycle characteristics of a battery through absorption of expansion and contraction of the silicon particles associated with charge and discharge by the lithium silicate phase.

Lithium silicate has no electron conductivity. Therefore, when the silicon particles dispersed in the lithium silicate phase release lithium and contract during discharging after the silicon particles occlude lithium and expand during charging, the electrical contact between silicon particles may be disconnected. When the electrical contact between silicon particles is disconnected, electron donation to the silicon particles is cut; consequently, the silicon particles are not allowed to release lithium and remain occluding lithium. As a result, discharge capacity is reduced relative to charge capacity. That is, charge-discharge efficiency of a battery decreases.

Electrical contact seems to be maintained when the content ratio of silicon, which has electron conductivity, is increased; however, it is not desirable to decrease the content ratio of lithium silicate from the viewpoint of easing expansion of silicon particles.

The present disclosure has been made in view of the above circumstances and provides a technique for improving charge-discharge efficiency of a battery using composite active material particles including silicon and lithium silicate. Outline of one aspect according to present disclosure

A composite active material particle according to a first aspect of the present disclosure includes:
a lithium silicate phase;
a plurality of silicon particles dispersed in the lithium silicate phase; and
an electron-conductive material dispersed in the lithium silicate phase, the electron-conductive material including a carbon material.

According to the first aspect, charge-discharge efficiency of a battery using the composite active material particle including silicon and lithium silicate can be improved.

In the composite active material particle according to the first aspect, the electron-conductive material includes the carbon material. The carbon material is lightweight and does not tend to adversely affect characteristics of a battery. Thus the carbon material is suitable as the electron-conductive material.

In a second aspect of the present disclosure, the electron-conductive material may include a metal material that does not alloy with lithium in the composite active material particle according to the first aspect, for example. Characteristics of a battery using the composite active material particle can be prevented from being affected by using the metal material that does not alloy with lithium.

In a third aspect of the present disclosure, the electron-conductive material may include at least one selected from the group consisting of elemental Ni and stainless steel in the composite active material particle according to the first or second aspect, for example. Elemental Ni and stainless steel have good electron conductivity and are thus recommended.

In a fourth aspect of the present disclosure, lithium silicate included in the lithium silicate phase may have a composition represented by Li_{2z}SiO_{(2+z)} (0<z≤2) in the composite active material particle according to any of the first to third aspects, for example. Expansion and contraction of the silicon particles may be significantly absorbed by lithium silicate having such a composition.

A battery according to a fifth aspect of the present disclosure includes:
a positive electrode;
a negative electrode; and
an electrolyte layer positioned between the positive electrode and the negative electrode, the negative electrode including the composite active material particle according to any one of the first to fourth aspects.

According to the present disclosure, charge-discharge efficiency of a battery can be improved.

In a sixth aspect of the present disclosure, the negative electrode may further include a solid electrolyte in the battery according to the fifth aspect, for example. The composite active material particle of the present disclosure is especially useful when a negative electrode active material layer includes the solid electrolyte.

Hereinafter, an embodiment of the present disclosure will be described with reference to drawings. The present disclosure is not limited to the following embodiment.

### EMBODIMENT

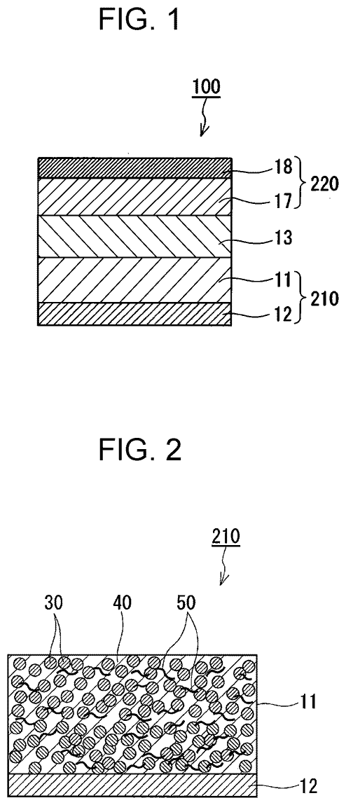

FIG. 1 is a sectional diagram illustrating a schematic configuration of a battery 100 in an embodiment. The battery 100 includes a positive electrode 220, a negative electrode 210, and an electrolyte layer 13.

The positive electrode 220 has a positive electrode active material layer 17 and a positive electrode current collector 18. The positive electrode active material layer 17 is disposed between the electrolyte layer 13 and the positive electrode current collector 18. The positive electrode active material layer 17 is in electrical contact with the positive electrode current collector 18.

The positive electrode current collector 18 is a member having a function to collect electric power from the positive electrode active material layer 17. Examples of the material for the positive electrode current collector 18 include aluminum, an aluminum alloy, stainless steel, copper, and nickel. The positive electrode current collector 18 may be made from aluminum or an aluminum alloy. The dimension, the shape, and the like of the positive electrode current collector 18 can be appropriately selected according to application of the battery 100.

The positive electrode active material layer 17 includes a positive electrode active material and a solid electrolyte. A material having characteristics of occluding and releasing metal ions such as lithium ions may be used as the positive electrode active material. A lithium-containing transition metal oxide, a transition metal fluoride, a polyanion material, a fluorinated polyanion material, a transition metal sulfide, a transition metal oxysulfide, a transition metal oxynitride, or the like may be used as the positive electrode active material. In particular, when a lithium-containing transition metal oxide is used as the positive electrode active material, production costs can be reduced, and average discharge voltage can be increased.

The positive electrode active material has, for example, a particulate shape. The shape of particles of the positive electrode active material is not particularly limited. The shape of the particles of the positive electrode active material may be a needle shape, a spherical shape, an oval spherical shape, or a scale shape.

The median diameter of the particles of the positive electrode active material may be greater than or equal to 0.1 μm and less than or equal to 100 μm. When the median diameter of the particles of the positive electrode active material is greater than or equal to 0.1 μm, the positive electrode active material and the solid electrolyte may form a good dispersion state in the positive electrode 220. As a result, the charge-discharge characteristics of the battery 100 improve. When the median diameter of the particles of the positive electrode active material is less than or equal to 100 μm, diffusion of lithium within the particles of the positive electrode active material accelerates. Therefore, the battery 100 may operate at high output.

At least one selected from the group consisting of a sulfide solid electrolyte, an oxide solid electrolyte, a halide solid electrolyte, a polymeric solid electrolyte, and a complex hydride solid electrolyte may be used as the solid electrolyte of the positive electrode 220. The oxide solid electrolyte has excellent high-potential stability. The charge-discharge efficiency of the battery 100 can be further improved by using the oxide solid electrolyte.

The volume ratio “v1:100-v1” between the positive electrode active material and the solid electrolyte in the positive electrode 220 may satisfy 30≤v1≤95. When 30≤v1 is satisfied, the energy density of the battery 100 is ensured sufficiently. When v1≤95 is satisfied, operation at high output is possible.

The thickness of the positive electrode 220 may be greater than or equal to 10 μm and less than or equal to 500 μm. When the thickness of the positive electrode 220 is greater than or equal to 10 μm, the energy density of the battery 100 is ensured sufficiently. When the thickness of the positive electrode 220 is less than or equal to 500 μm, operation at high output is possible.

When the shape of the solid electrolyte included in the positive electrode 220 is particulate (for example, spherical), the median diameter of a particle group of the solid electrolyte may be less than or equal to 100 μm. When the median diameter is less than or equal to 100 μm, the positive electrode active material and the solid electrolyte may form a good dispersion state in the positive electrode 220. Consequently, the charge-discharge characteristics of the battery 100 improve.

The “median diameter” herein means a particle diameter at which the cumulative volume in a volume-based particle size distribution is equal to 50%. The volume-based particle size distribution is measured by a laser diffraction-type measurement device or an image analysis device, for example.

The positive electrode active material layer 17 may include a conductive assistant for the purpose of enhancing electron conductivity. For example, graphite like natural graphite or artificial graphite, carbon black such as acetylene black or Ketjen black, conductive fibers such as carbon fibers or metal fibers, metal powder of carbon fluoride, aluminum, or the like, conductive whiskers of zinc oxide, potassium titanate, or the like, a conductive metal oxide such as titanium oxide, a conductive polymer compound such as a polyaniline, a polypyrrole, or a polythiophene, or the like may be used as the conductive assistant. When a carbon conductive assistant is used, reduction in costs can be expected.

The electrolyte layer 13 is positioned between the positive electrode 220 and the negative electrode 210. The electrolyte layer 13 is a layer including an electrolyte. The electrolyte is, for example, a solid electrolyte. The electrolyte layer 13 may be a solid electrolyte layer.

The electrolyte layer 13 may include, as the solid electrolyte, at least one selected from the group consisting of a halide solid electrolyte, a sulfide solid electrolyte, an oxide solid electrolyte, a polymeric solid electrolyte, and a complex hydride solid electrolyte.

The electrolyte layer 13 may have a multi-layered structure. In this case the material composition of a layer in contact with the negative electrode 210 may differ from the material composition of a layer in contact with the positive electrode 220. The layer in contact with the negative electrode 210 may be formed from a sulfide solid electrolyte excellent in reduction resistance. The layer in contact with the positive electrode 220 may be formed from a halide solid electrolyte excellent in oxidation resistance.

The solid electrolyte included in the electrolyte layer 13 has, for example, a particulate shape. The shape of particles is not particularly limited and is, for example, a needle shape, a spherical shape, or an oval spherical shape.

The thickness of the electrolyte layer 13 may be greater than or equal to 1 μm and less than or equal to 300 μm. When the thickness of the electrolyte layer 13 is greater than or equal to 1 μm, short circuit between the positive electrode 220 and the negative electrode 210 can be surely prevented. When the thickness of the electrolyte layer 13 is less than or equal to 300 μm, operation at high output can be realized.

The negative electrode 210 includes a negative electrode active material layer 11 and a negative electrode current collector 12. The negative electrode active material layer 11 is disposed between the electrolyte layer 13 and the negative electrode current collector 12. The negative electrode active material layer 11 is in electrical contact with the negative electrode current collector 12.

The negative electrode current collector 12 is a member having a function to collect electric power from the negative electrode active material layer 11. Examples of the material for the negative electrode current collector 12 include aluminum, an aluminum alloy, stainless steel, copper, and nickel. The negative electrode current collector 12 may be made from nickel. The dimension, the shape, and the like of the negative electrode current collector 12 can be appropriately selected according to application of the battery 100.

FIG. 2 is a sectional diagram illustrating a detailed configuration of the negative electrode 210 and the negative electrode active material layer 11. The negative electrode active material layer 11 includes composite active material particles 30 as a negative electrode active material.

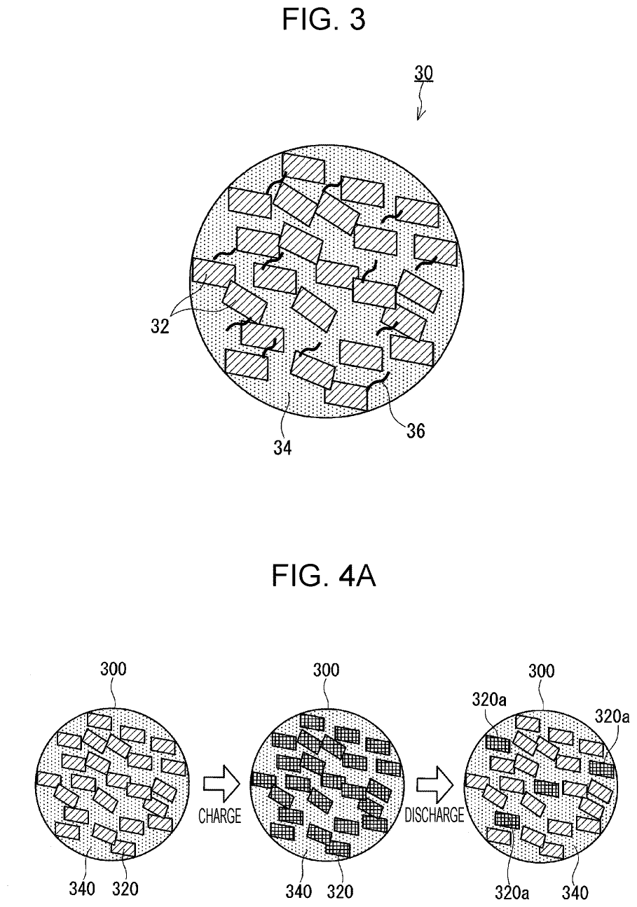

FIG. 3 is a sectional diagram illustrating a schematic configuration of the composite active material particles 30. The composite active material particles 30 include a plurality of silicon particles 32, a lithium silicate phase 34, and an electron-conductive material 36. The plurality of silicon particles 32 is dispersed in the lithium silicate phase 34. The electron-conductive material 36 is dispersed in the lithium silicate phase 34. The electron-conductive material 36 also has a particulate shape. A plurality of particles of the electron-conductive material 36 is dispersed in the lithium silicate phase 34.

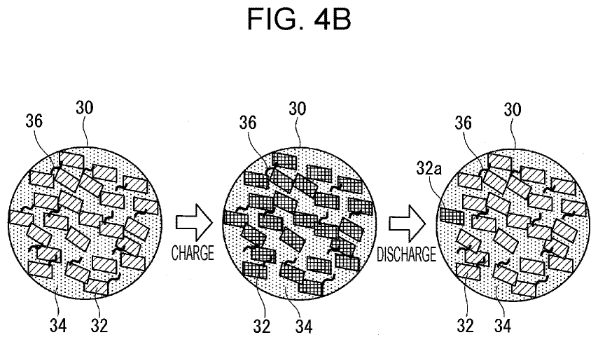

FIG. 4A is a diagram explaining a problem of composite active material particles in the related art (for example, International Publication No. 2016/136180). When a battery using composite active material particles 300 in the related art as a negative electrode active material is charged, silicon particles 320 dispersed in a lithium silicate phase 340 occlude lithium and expand. Thereafter, upon discharging the battery, the silicon particles 320 release lithium and contract. At this time, electrical contact between the silicon particles 320 is disconnected to produce isolated silicon particles 320a. The isolated silicon particles 320a cannot receive electrons from the outside, thus are not allowed to release lithium, and remain occluding lithium. As a result, discharge capacity decreases relative to charge capacity. That is, charge-discharge efficiency of the battery decreases.

FIG. 4B is a diagram explaining an effect provided by the composite active material particles 30 of the present embodiment. When a battery using the composite active material particles 30 of the present embodiment as a negative electrode active material is charged, the silicon particles 32 dispersed in the lithium silicate phase 34 occlude lithium and expand. Thereafter, upon discharging the battery, the silicon particles 32 release lithium and contract. Since an electrical network in the lithium silicate phase 34 is maintained by the electron-conductive material 36 even when the silicon particles 32 contract during discharging the battery, electrical contact between silicon particles 32 is prevented from being disconnected. When electrical contact between silicon particles 32 is maintained, electrons are donated to each of the silicon particles 32; therefore, each of the silicon particles 32 can release lithium. Isolated silicon particles 32a are also produced, but the number thereof is small. As a result, decrease in discharge capacity relative to charge capacity is suppressed. That is, decrease in charge-discharge efficiency of the battery can be suppressed.

The composite active material particles 30 may be primary particles. The lithium silicate phase 34 may be a continuous phase without clear grain boundaries.

The silicon particles 32 are particles of elemental silicon. The purity of silicon in the silicon particles 32 is not particularly limited and is, for example, greater than or equal to 99% (2N). The silicon particles 32 may be single crystal silicon particles or may be polycrystal silicon particles.

The size of the silicon particles 32 is not particularly limited. The silicon particles 32 may have a size in the order of nanometers. An average particle diameter of the silicon particles 32 is, for example, greater than or equal to 0.01 μm and less than or equal to 3 μm. The average particle diameter of the silicon particles 32 can be calculated by the following method, for example. For example, a section of the composite active material particles 30 is observed with an electron microscope (SEM or TEM), and an area of a certain silicon particle 32 in a microscope image is calculated through image processing. The diameter of a circle having an area equal to the calculated area is considered to be the diameter of the certain silicon particle 32. Diameters of a given number (for example, ten) of the silicon particles 32 are calculated, and the average value thereof is considered to the average particle diameter of the particles.

In FIG. 3, the silicon particles 32 have an approximately constant size. However, a silicon phase having a shape that is difficult to consider as a particle may be present in the lithium silicate phase 34. For example, a relatively large phase may be formed through coalescence of some of the silicon particles 32. A phase formed by the silicon particles 32 and the lithium silicate phase 34 may exhibit a dappled pattern in some cases. The shape of the silicon particles 32 is also not particularly limited. The silicon particles 32 have, for example, a spherical shape, an oval spherical shape, a scale shape, or the like.

The lithium silicate phase 34 may be a phase including lithium silicate having a composition represented by Li_{2z}SiO_{(2+z)} (0<z≤2). The silicon particles 32 and the electron-conductive material 36 are embedded in a lithium silicate matrix. Expansion and contraction of the silicon particles 32 can be significantly absorbed by lithium silicate having such a composition. Specific examples of the composition of crystalline lithium silicate include Li₄SiO₄ (z=2), Li₂SiO₃ (z=1), and Li₂Si₂O₅ (z=½). The lithium silicate phase 34 may include lithium silicate of a single composition or may include lithium silicate of multiple compositions. Lithium silicate may be amorphous. In the case of amorphous lithium silicate, “z” described above may take a value other than ½, 1, and 2 as multiple compositions of lithium silicate are combined.

The electron-conductive material 36 has a particulate shape and dispersed in the lithium silicate phase 34. The particles of the electron-conductive material 36 are desirably uniformly dispersed in the lithium silicate phase 34. The shape of the electron-conductive material 36 is not particularly limited. The electron-conductive material 36 has, for example, a spherical shape, an oval spherical shape, a scale shape, a fibrous shape, or the like.

The electron-conductive material 36 includes, for example, a carbon material. The carbon material is lightweight and does not tend to adversely affect characteristics of a battery. Thus the carbon material is suitable as the electron-conductive material 36. Examples of the carbon material include graphite, graphene, vapor-grown carbon fibers, carbon nanotubes, and acetylene black. At least one selected from these carbon materials can be used as the electron-conductive material 36.

The electron-conductive material 36 may include a metal material that does not alloy with lithium. By virtue of using the metal material that does not alloy with lithium, characteristics of a battery using the composite active material particles 30 can be prevented from being affected. Examples of the metal material that can be used as the electron-conductive material 36 include elemental Ni, elemental Fe, stainless steel, and elemental Cu. The electron-conductive material 36 may include at least one selected from these metal materials. Elemental Ni and stainless steel have good electron conductivity and are thus recommended. The type of stainless steel is not particularly limited, and any of austenite-based stainless steel such as SUS304, martensite-based stainless steel such as SUS410, and ferrite-based stainless steel such as SUS430 can be used. The composite active material particles 30 may include both of the carbon material and the metal material as the electron-conductive material 36.

The particles of the electron-conductive material 36 have, for example, an average particle diameter within a range of greater than or equal to 0.001 μm and less than or equal to 3 μm. The average particle diameter of the particles of the electron-conductive material 36 can be measured by the same method as the measurement method for the average particle diameter of the silicon particles 32.

The composite active material particles 30 have an average particle diameter within a range of greater than or equal to 0.1 μm and less than or equal to 10 μm, for example. The average particle diameter of the composite active material particles 30 can also be measured by the same method as the measurement method for the average particle diameter of the silicon particles 32. When the average particle diameter of the composite active material particles 30 is properly adjusted, the composite active material particles 30 and the solid electrolyte can form a good dispersion state in the negative electrode 210. Charge-discharge characteristics of the battery 100 improve thereby. In addition, diffusion of lithium in the composite active material particles 30 is accelerated. The battery 100 can operate at high output therefore.

A ratio of the mass of the silicon particles 32 (total mass of the silicon particles 32) to the mass of the lithium silicate phase 34 in the composite active material particles 30 is, for example, greater than or equal to 20% and less than or equal to 80%. The lithium silicate phase 34 can significantly absorb expansion and contraction of the silicon particles 32 by properly adjusting the ratio.

A ratio of the mass of the electron-conductive material 36 to the total mass of the silicon particles 32 and the lithium silicate phase 34 may be greater than or equal to 0.1% by mass and less than or equal to 10% by mass and may be greater than or equal to 0.5% by mass and less than or equal to 7% by mass. An effect of improving charge-discharge efficiency exceeding decrease in weight energy density due to addition of the electron-conductive material 36 can be obtained by properly adjusting the content ratio of the electron-conductive material 36.

The content ratio of the electron-conductive material 36 can be calculated from a result of quantification analysis on the composite active material particles 30, with elements such as C, Ni, and Fe focused on.

The composite active material particles 30 can be, for example, produced by the method described below. First, silicon powder, lithium silicate powder, and the electron-conductive material 36 are prepared. The silicon powder, the lithium silicate powder, and the electron-conductive material 36 are mixed at a predetermined ratio to obtain raw material powder. The raw material powder is processed by a method like mechanical alloying. The composite active material particles 30 are obtained in this manner. The composite active material particles 30 (powder) having a desired average particle diameter are obtained through processing of the composite active material particles 30 using a mesh or a sieve with a predetermined mesh size.

The negative electrode active material layer 11 may further include a solid electrolyte 40. At least one selected from the group consisting of a sulfide solid electrolyte, an oxide solid electrolyte, a halide solid electrolyte, a polymeric solid electrolyte, and a complex hydride solid electrolyte may be used as the solid electrolyte 40.

When the negative electrode active material layer 11 includes the solid electrolyte 40, in other words, when the battery 100 is a solid battery, the space for expansion and contraction of the silicon particles is limited. Therefore, from the viewpoint of charge-discharge efficiency, it is not easy to directly disperse the silicon particles in the negative electrode active material layer 11 and use same. Accordingly, the composite active material particles 30 of the present embodiment are especially useful when the negative electrode active material layer 11 includes the solid electrolyte 40.

Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like may be used as the sulfide solid electrolyte. LiX, Li₂O, MO_{q}, LiₚMO_{q}, or the like may be added thereto. Here, the element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The symbols p and q in “MO_{q}” and “LiₚMO_{q}” are each independently a natural number.

For example, a NASICON-type solid electrolyte typified by LiTi₂(PO₄)₃ and an element substitution product thereof, a (LaLi)TiO₃-based perovskite-type solid electrolyte, a LISICON-type solid electrolyte typified by Li₁₄ZnGe₄O₁₆, Li₄SiO₄, LiGeO⁴, and an element substitution product thereof, a garnet-type solid electrolyte typified by Li₇La₃Zr₂O₁₂ and an element substitution product thereof, Li₃N and a H substitution product thereof, Li₃PO₄ and a N substitution product thereof, or glass or glass ceramic in which a material such as Li₂SO₄ or Li₂CO₃ is added to a base material including a Li—B—O compound such as LiBO₂ or Li₃BO₃ may be used as the oxide solid electrolyte.

For example, a compound of a polymer compound and a lithium salt may be used as the polymeric solid electrolyte. The polymer compound may have an ethylene oxide structure. When the polymer compound has an ethylene oxide structure, a greater amount of the lithium salt can be contained therein, and ion conductivity can thus be enhanced. LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like may be used as the lithium salt. One lithium salt selected therefrom may be used alone, or a mixture of two or more lithium salts selected therefrom may be used, as the lithium salt.

For example, LiBH₄—LiI, LiBH₄—P₂S₅, or the like may be used as the complex hydride solid electrolyte.

The halide solid electrolyte is represented by formula (1) below, for example. In formula (1), α, β, and γ are each independently a value larger than 0. M includes at least one element selected from the group consisting of metal elements other than Li and semimetal elements. X includes at least one selected from the group consisting of F, Cl, Br, and I.

Li_{α}M_{β}X_{γ} (1)

The semimetal elements include B, Si, Ge, As, Sb, and Te. The metal elements include all elements included in Group 1 to Group 12 elements in the periodic table except for hydrogen and all elements included in Group 13 to Group 16 elements in the periodic table except for B, Si, Ge, As, Sb, Te, C, N, P, O, S, and Se. The metal elements are an element group which may be cations when forming an inorganic compound with a halogen compound.

Li₃YX₆, Li₂MgX₄, Li₂FeX₄, Li(Al,Ga,In)X₄, Li₃(Al,Ga,In)X₆, or the like may be used as the halide solid electrolyte.

When an element in a formula is represented by, for example, “(Al,Ga,In)” in the present disclosure, this representation indicates at least one element selected from the element group in the parentheses. That is, “(Al,Ga,In)” has the same meaning as “at least one element selected from the group consisting of Al, Ga, and In.” The same is true for the case of other elements. The halide solid electrolyte exhibits excellent ion conductivity.

The respective solid electrolytes described above can be used not only for the negative electrode 210 but also for the positive electrode 220 and the electrolyte layer 13.

When the volume ratio between the composite active material particles 30 and the solid electrolyte 40 in the negative electrode 210 is represented by “v2:100-v2,” the volume ratio v2 of the composite active material particles 30 may satisfy 30≤v2≤95. When 30≤v2 is satisfied, the energy density of the battery 100 is ensured sufficiently. When v2≤95 is satisfied, operation at high output is possible.

The average particle diameter of the composite active material particles 30 may be larger than the median diameter of particles of the solid electrolyte 40 included in the negative electrode 210. The composite active material particles 30 and the solid electrolyte 40 can form a good dispersion state thereby.

The thickness of the negative electrode 210 may be greater than or equal to 10 μm and less than or equal to 500 μm. When the thickness of the negative electrode 210 is greater than or equal to 10 μm, the energy density of the battery 100 is ensured sufficiently. When the thickness of the negative electrode 210 is less than or equal to 500 μm, operation at high output is possible.

The negative electrode active material layer 11 may include a conductive assistant 50 for the purpose of enhancing electron conductivity. Materials listed as the conductive assistant which may be included in the positive electrode active material layer 17 can be used as the conductive assistant 50.

At least one of the positive electrode active material layer 17, the electrolyte layer 13, and the negative electrode active material layer 11 may include a nonaqueous electrolyte solution, a gel electrolyte, or an ionic liquid for the purpose of facilitating transfer of lithium ions and improving output characteristics of a battery.

The nonaqueous electrolyte solution includes a nonaqueous solvent and a lithium salt dissolved in the nonaqueous solvent. Examples of the nonaqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxy ethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate. As the nonaqueous solvent, one nonaqueous solvent selected therefrom may be used alone, or a mixture of two or more nonaqueous solvents selected therefrom may be used. The nonaqueous electrolyte solution may include at least one fluorinated solvent selected from the group consisting of fluoroethylene carbonate, methyl fluoropropionate, fluorobenzene, fluoroethyl methyl carbonate, and fluorodimethylene carbonate.

Examples of the lithium salt include LiPH₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected therefrom may be used alone, or a mixture of two or more lithium salts selected therefrom may be used. The concentration of the lithium salt ranges, for example, from 0.5 to 2 mol/liter.

A polymer material impregnated with a nonaqueous electrolyte solution can be used as the gel electrolyte. At least one selected from the group consisting of polyethylene oxide, polyacrylonitrile, polyvinylidene fluoride, polymethyl methacrylate, and a polymer having an ethylene oxide bond may be used as the polymer material.

A cation constituting the ionic liquid may be, for example, a cation including aliphatic chain quaternary salts such as tetraalkyl ammoniums and tetraalkyl phosphoniums; aliphatic cyclic ammoniums such as pyrrolidiniums, morpholiniums, imidazoliniums, tetrahydro pyrimidiniums, piperaziniums, and piperidiniums; and nitrogen-containing hetero aromatic cations such as pyridiniums and imidazoliums. An anion constituting the ionic liquid may be PF₆⁻, BF₄⁻, SbF₆⁻, AsF₆⁻, SO₃CF₃⁻, N(SO₂CF₃)₂⁻, N(SO₂CF₅)₂⁻, N(SO₂CF₃)(SO₂C₄F₉)⁻, C(SO₂CH₃)₃⁻, or the like. The ionic liquid may contain a lithium salt.

At least one of the positive electrode active material layer 17, the electrolyte layer 13, and the negative electrode active material layer 11 may include a binder for the purpose of improving adhesiveness between particles. The binder is used for improving binding properties of material constituting an electrode. Examples of the binder include a polyvinylidene fluoride, a polytetrafluoroethylene, a polyethylene, a polypropylene, an aramid resin, a polyamide, a polyimide, a polyamideimide, a polyacrylonitrile, a polyacrylic acid, a polymethyl acrylate, a polyethyl acrylate, a polyhexyl acrylate, a polymethacrylic acid, a polymethyl methacrylate, a polyethyl methacrylate, a polyhexyl methacrylate, a polyvinyl acetate, a polyvinyl pyrrolidone, a polyether, a polyether sulfone, a hexafluoropolypropylene, stylene butadiene rubber, and carboxymethyl cellulose. In addition, a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may be used as the binder. Two or more selected therefrom may be mixed and used as the binder.

The battery 100 in the present embodiment may be configured as batteries with various shapes such as a coin-type battery, a cylindrical battery, a square-type battery, a sheet-type battery, a button-type battery, a flat-type battery, a laminate-type battery, and the like.

### EXAMPLES

Hereinafter, details of the present disclosure will be described using examples and a comparative example.

### Production of Sulfide Solid Electrolyte

Li₂S and P₂S₅ were weighed in a globe box with an Ar atmosphere having a dew point of less than or equal to −60° C. such that Li₂S:P₂S₅=75:25 in terms of mole ratio. The weighed Li₂S and P₂S₅ were pulverized with a mortar and mixed to obtain a mixture. Thereafter, the mixture was subjected to milling processing under conditions of 10 hours and 510 rpm using a planetary ball mill (manufactured by Fritsch Japan Co., Ltd, P-7 model) to obtain a glass solid electrolyte. The glass solid electrolyte was subjected to heat treatment under conditions of 270 degrees and 2 hours in an inert atmosphere. Powder of Li₂S—P₂S₅, which was glass ceramic sulfide solid electrolyte, was obtained thereby. Hereinafter, the Li₂S—P₂S₅ powder is also simply referred to as the “LPS.”

### Example 1

### Production of Composite Active Material Particles

Si powder (3N, 2.5 μm pulverized product) and Li₂SiO₃ powder (2N, 10 μm pulverized product) were mixed, at a mass ratio of 1:1, in a globe box with an Ar atmosphere having a dew point of less than or equal to −60° C. to obtain mixed powder. To the mixed powder was added 5% by mass of vapor-grown carbon fibers (Showa Denko K.K., VGCF-H) to obtain raw material powder. A pod (made from SUS, volume: 45 mL) of a planetary ball mill was filled with the raw material powder. To the bod was added 60 g of SUS balls (diameter: 5 mm), the lid was closed, and the raw material powder was subjected to pulverization processing under the conditions of 200 rpm and 50 hours. Thereafter, the processed powder was passed through a mesh with a mesh size of 45 μm to remove coarse particles. The average particle diameter of the powder was further adjusted to about 20 μm by removing fine particles using a sieve with a small mesh size. Consequently, composite active material particles of Example 1 were obtained. “VGCF” is a registered trademark of Showa Denko K.K.

The composite active material particles of Example 1 had the structure described with reference to FIG. 3. Observation of a section of the composite active material particles and elemental analysis thereon were carried out with scanning electron microscopy-energy dispersive X-ray spectroscopy (SEM-EDX). As a result, it was demonstrated that nanosized carbon particles were uniformly dispersed on the section of the composite active material particles. However, no fibrous substance was observed even the section of the composite active material particles was observed with a scanning electron microscope. It is considered that the carbon fibers were cut into short pieces through synthesis using a ball mill.

Note that, the particle diameters of the Si powder used in Example 1, the Ni powder used in Example 2, and the SUS powder used in Example 3 were relatively large. However, the Si particles, the Ni particles, and the SUS particles were pulverized through synthesis process using a ball mill and taken into the lithium silicate phase, and the sizes of the Si powder, the Ni powder, and the SUS powder as starting materials are not particularly limited.

### Production of Negative Electrode Material

The composite active material particles of Example 1 and the LPS were mixed, at a mass ratio of 7:3, in a globe box with an Ar atmosphere having a dew point of less than or equal to −60° C. to obtain a mixture. To the mixture was added 5% by mass of vapor-grown carbon fibers, followed by mixing. A negative electrode material of Example 1 was obtained thereby.

### Production of Positive Electrode Material

Li(Ni_{0.33}Co_{0.33}Mn_{0.33})O₂ and the LPS were mixed, at a mass ratio of 7:3, in a globe box with an Ar atmosphere having a dew point of less than or equal to −60° C. A positive electrode material was obtained thereby. The positive electrode material was common in Examples and Comparative Example.

### Production of Secondary Battery

First, 4 mg of the LPS and 10 mg of the negative electrode material were placed in an insulating external cylinder, and the LPS and the negative electrode material were pressurized and molded at a pressure of 360 MPa to obtain a laminated body of a negative electrode active material layer and a solid electrolyte layer.

Thereafter, the negative electrode active material layer and copper foil (thickness: 12 μm) thereon were laminated. The laminate was pressurized and molded at a pressure of 360 MPa to obtain a negative electrode of Example 1.

Thereafter, the solid electrolyte layer and 100 mg of the positive electrode material thereon were laminated, and the laminate was pressurized and molded at a pressure of 360 MPa to obtain a laminated body including the negative electrode, the solid electrolyte layer, and a positive electrode active material layer.

Thereafter, the positive electrode active material layer and aluminum foil thereon were laminated. The laminate was pressurized and molded at a pressure of 360 MPa to obtain a laminated body including the positive electrode, the solid electrolyte layer, and the negative electrode.

Thereafter, a stainless-steel current collector was disposed on the top and the bottom of the laminated body, and a current-collecting lead was attached to the current collector.

Finally, the insulating external cylinder was sealed using an insulating ferrule, and the inside of the insulating external cylinder was blocked from the external air atmosphere to produce a battery of Example 1.

### Example 2

### Production of Composite Active Material Particles

Composite active material particles of Example 2 were produced in the same manner as Example 1 except that Ni powder (manufactured by Kojundo Chemical Laboratory Co., Ltd., 3N, 3 to 5 μm) was used instead of the vapor-grown carbon fibers. The composite active material particles of Example 2 had the structure described with reference to FIG. 3.

### Production of Negative Electrode Material

The composite active material particles of Example 2 and the LPS were mixed, at a mass ratio of 7:3, in a globe box with an Ar atmosphere having a dew point of less than or equal to −60° C. to obtain a mixture. To the mixture was added 10% by mass of vapor-grown carbon fibers, followed by mixing. A negative electrode material of Example 2 was obtained thereby.

### Production of Secondary Battery

A battery of Example 2 was produced in the same manner as Example 1 except that the negative electrode material of Example 2 was used instead of the negative electrode material of Example 1.

### Example 3

### Production of Composite Active Material Particles

Composite active material particles of Example 3 were produced in the same manner as Example 1 except that SUS304 powder (manufactured by Kojundo Chemical Laboratory Co., Ltd., less than or equal to 150 μm) was used instead of the vapor-grown carbon fibers. The composite active material particles of Example 3 had the structure described with reference to FIG. 3.

### Production of Negative Electrode Material

The composite active material particles of Example 3 and the LPS were mixed, at a mass ratio of 7:3, in a globe box with an Ar atmosphere having a dew point of less than or equal to −60° C. to obtain a mixture. To the mixture was added 10% by mass of vapor-grown carbon fibers, followed by mixing. A negative electrode material of Example 3 was obtained thereby.

### Production of Secondary Battery

A battery of Example 3 was produced in the same manner as Example 1 except that the negative electrode material of Example 3 was used instead of the negative electrode material of Example 1.

### Example 4

### Production of Composite Active Material Particles

Composite active material particles of Example 4 were produced in the same manner as Example 2 except that the mass ratio of the Ni powder to the mass of the mixed powder of the Si powder and the Li₂SiO₃ powder was changed to 1%. The composite active material particles of Example 4 had the structure described with reference to FIG. 3.

### Production of Negative Electrode Material

The composite active material particles of Example 4 and the LPS were mixed, at a mass ratio of 7:3, in a globe box with an Ar atmosphere having a dew point of less than or equal to −60° C. to obtain a mixture. To the mixture was added 10% by mass of vapor-grown carbon fibers, followed by mixing. A negative electrode material of Example 4 was obtained thereby.

### Production of Secondary Battery

A battery of Example 4 was produced in the same manner as Example 1 except that the negative electrode material of Example 4 was used instead of the negative electrode material of Example 1.

### Comparative Example 1

### Production of Composite Active Material Particles

Composite active material particles of Comparative Example 1 were produced in the same manner as Example 1 except that no vapor-grown carbon fiber was used.

### Production of Negative Electrode Material

The composite active material particles of Comparative Example 1 and the LPS were mixed, at a mass ratio of 7:3, in a globe box with an Ar atmosphere having a dew point of less than or equal to −60° C. to obtain a mixture. To the mixture was added 10% by mass of vapor-grown carbon fibers, followed by mixing. A negative electrode material of Comparative Example 1 was obtained thereby.

### Production of Secondary Battery

A battery of Comparative Example 1 was produced in the same manner as Example 1 except that the negative electrode material of Comparative Example 1 was used instead of the negative electrode material of Example 1.

### Charge-Discharge Test

Charge-discharge tests were carried out under the following conditions using the batteries of Examples 1 to 3 and Comparative Example 1. Note that the theoretical capacities of the batteries of Examples and Comparative Example were identical to one another.

Each of the batteries was placed in an isothermal bath at 25° C.

Constant-current charge was conducted at a current value of 770 μA, achieving a rate of 0.05 C (20 hours rate) relative to the theoretical capacity of the batteries, and the charge was stopped at a voltage of 4.2 V.

Thereafter, constant-current discharge was conducted at a current value of 770 μA, achieving a rate of 0.05 C (20 hours rate), and the discharge was stopped at a voltage of 2 V.

From results of the above charge-discharge tests, initial charge-discharge efficiency was calculated. Initial charge-discharge efficiency is a value obtained by 100×(initial discharge capacity at 0.05 C)/(initial charge capacity at 0.05 C). Results are shown in Table 1.

TABLE 1

| | Electron- | Ratio of | Initial |
|---|---|---|---|
| | conductive | electron-conductive | charge-discharge |
| | material | material (mass %) | efficiency (%) |
| Example 1 | Carbon fiber | 5 | 98.0 |
| Example 2 | Ni particle | 5 | 97.9 |
| Example 3 | SUS particle | 5 | 98.4 |
| Example 4 | Ni particle | 1 | 97.4 |
| Comparative | — | — | 92.8 |
| Example 1 | | | |

### DISCUSSION

The batteries of Examples 1 to 4 all exhibited high initial charge-discharge efficiency. It is considered that the electron-conductive material embedded in the composite active material particles functioned to maintain electrical contact between silicon particles when the silicon particles in the composite active material particles having expanded through charging contracted at the time of discharging, and the number of silicon particles that were electrically isolated and could not be discharged was reduced thereby.

On the other hand, the initial charge-discharge efficiency of the battery of Comparative Example 1 was low. It is considered that electrical contact between silicon particles was disconnected when the silicon particles in the composite active material particles having expanded through charging contracted at the time of discharging, and certain silicon particles were electrically isolated during discharging, leading to decrease in discharge capacity.

The ratio of the mass of the electron-conductive material to the total mass of the silicon particles and the lithium silicate phase was 5% in each of Examples 1 to 3. As understood from the result of Example 4, approximately the same effect was obtained when the ratio was changed to 1%.

The technique of the present disclosure is useful for, for example, lithium batteries such as all-solid-state lithium secondary batteries and nonaqueous electrolyte lithium-ion batteries.

What is claimed is:

1. A composite active material particle comprising:
a lithium silicate phase;
a plurality of silicon particles dispersed in the lithium silicate phase; and
an electron-conductive material dispersed in the lithium silicate phase,
the electron-conductive material including a carbon material.

2. The composite active material particle according to claim 1, wherein
the electron-conductive material includes a metal material that does not alloy with lithium.

3. The composite active material particle according to claim 1, wherein
the electron-conductive material includes at least one selected from the group consisting of elemental Ni and stainless steel.

4. The composite active material particle according to claim 1, wherein
lithium silicate included in the lithium silicate phase has a composition represented by Li_{2z}SiO_{(2+z)} (0<z≤2).

5. A battery comprising:
a positive electrode;
a negative electrode; and
an electrolyte layer positioned between the positive electrode and the negative electrode, wherein
the negative electrode includes the composite active material particle according to claim 1.

6. The battery according to claim 5, wherein
the negative electrode further includes a solid electrolyte.
